(19) United States
(12) Patent Application Publication
(10) Pub. No.: US 2024/0094700 A1
(43) Pub. Date: Mar. 21, 2024

(54) RESHAPING METHOD FOR METAL PARODUCT AND ELECTRONIC DEVICE

(71) Applicant: FU DING ELECTRONICAL TECHNOLOGY (JIASHAN) CO.,LTD., Jiashan (CN)

(72) Inventors: YU XIA, Kunshan (CN); JI-CHAO XU, Kunshan (CN); LIN-FEI QIU, Kunshan (CN); JIAN-GUANG GAO, Kunshan (CN); FENG LIU, Kunshan (CN); XIN-ZHI WANG, Kunshan (CN)

(21) Appl. No.: 18/274,457

(22) PCT Filed: Sep. 30, 2021
(86) PCT No.: PCT/CN2021/122389

§ 371 Date: Jul. 26, 2023

(51) Int. Cl. G05B 19/4093; G05B 19/29; G05B 19/4099

(52) U.S. Cl. CPC G05B 19/40932; G05B 19/29; G05B 19/4099

(57) ABSTRACT

A reshaping method for metal product includes acquiring position data information of a workpiece; converting the position data information into coordinate information, and fitting the coordinate information to obtain a surface contour curve of the workpiece; comparing the surface contour curve with a standard contour curve to generate a comparison result; obtaining reshaping information of the workpiece based on the comparison result; and controlling the reshaping system to reshape the workpiece. The disclosure acquires position data information of the workpiece by measuring, converts the position data information into coordinate information, fits the coordinate information to obtain the surface contour curve of the workpiece, compares the surface contour curve with the standard contour curve to obtain deformation situation, and reshapes the workpiece according to the reshaping information based on the deformation situation, which improves efficiency of workpiece reshaping and reducing labor costs. An electronic device is also provided.

### FIELD

The subject matter relates to workpiece reshaping technologies, particularly to a reshaping method for metal product and an electronic device.

### BACKGROUND

During production and processing, workpieces are prone to deformation. It is often necessary to reshape the workpieces with unacceptable flatness.

Since the degree of deformation varies for each workpiece, the corresponding reshaping method required also differs. Currently, a common method for reshaping metal products is to manually reshape the workpiece based on the degree of deformation, which is determined by the naked eye. However, such manner requires high labor costs and low reshaping efficiency.

### SUMMARY

In light of the above, it is necessary to provide a reshaping method for metal product and an electronic device to solve the technical problems of large investment in labor costs and low shaping efficiency due to a manual shaping method which relying on the manual eye to determine the degree of deformation of the workpiece.

The disclosure provides a reshaping method for metal product, including:
acquiring position data information of a workpiece, the position data information is obtained by a measurement system measuring the workpiece;
converting the position data information into coordinate information, and fitting the coordinate information to obtain a surface contour curve of the workpiece;
comparing the surface contour curve with a standard contour curve to generate a comparison result;
obtaining reshaping information of the workpiece based on the comparison result; and
controlling a reshaping system to reshape the workpiece according to the reshaping information.

Therefore, the disclosure acquires position data information of the workpiece by using the measuring system to measure the surface of the workpiece, converts the position data information into coordinate information, fits the coordinate information to obtain the surface contour curve of the workpiece, compares the surface contour curve with the standard contour curve to obtain deformation situation to obtain the comparison result, obtains the reshaping information, and controls the reshaping system to reshape the workpiece according to the reshaping information. The disclosure automatic reshapes the workpiece according to the reshaping information based on deformation situation of the workpiece obtained by comparing the surface contour curve with the standard contour curve, which improves efficiency of workpiece reshaping and reducing labor costs.

According to some embodiments, converting the position data information into coordinate information, and fitting the coordinate information to obtain a surface contour curve of the workpiece further includes:
establishing a measurement coordinate system and binding the measurement coordinate system with the position information of the workpiece;
converting the position data information into coordinate information based on the binding between the measurement coordinate system and the position information of the workpiece; and
fitting the coordinate information to obtain the surface contour curve of the workpiece.

Therefore, the position information of the workpiece is bound with the measurement coordinate system to convert the position data information into coordinate information. The coordinate information is fitted to obtain the surface contour curve of the workpiece, such that the contour curve of the workpiece surface is obtained by measurement and calculations. This facilitates analysis of the deformation of the workpiece and enables visualization of the deformation of the workpiece. In this embodiment, the surface contour curve represents contour line of the workpiece surface.

According to some embodiments, fitting the coordinate information to obtain the surface contour curve of the workpiece further includes:
obtaining coordinate values (X, Y, Z) of each target position point on the workpiece based on a correspondence between the coordinate information and each position point;
calculating an ideal plane equation Z=AX+BY+C to obtain a planarity deviation value of each position point on the workpiece by a multi-point least squares method; and
fitting and obtaining the surface contour curve of the workpiece based on the obtained planarity deviation value of each position point on the workpiece.

Therefore, the planarity deviation value of each position point on the workpiece can be obtained by calculating an ideal plane equation Z=AX+BY+C using the multi-point least squares method. Then the surface contour curve of the workpiece can be obtained by fitting based on the calculated planarity deviation value of each position point on the workpiece, which enables visualization of the deformation of the workpiece.

According to some embodiments, comparing the surface contour curve with a standard contour curve to generate a comparison result further includes:
comparing the surface contour curve with the standard contour curve to obtain a deformation amount of each target position point on the workpiece;
generating a judgment result by determining whether the deformation amount of each target position point falls within a predetermined range; and
generating the comparison result based on the judgment result.

Therefore, the deformation amount of each target position point on the workpiece is obtained by comparing the surface contour curve with the standard contour curve, and the judgment result can be obtained by determining whether the deformation amount of each target position point falls within the predetermined range. The comparison result is generated according to the judgment result to enable an automatically comparison between the deformation amount of each target position point falls and the predetermined range.

According to some embodiments, generating the judgment result by determining whether the deformation amount of each target position point falls within the predetermined range further including:
determining the workpiece to be qualified if the deformation amount of each target position point of the workpiece falls within the predetermined range, and
determining the workpiece to be unqualified if the deformation amount of at least one target position point is outside the predetermined range.

Therefore, the workpiece can be determined to be qualified or unqualified by comparing the deformation amount of each target position point with the predetermined range and determining whether the deformation amount of each target position point falls within the predetermined range.

According to some embodiments, obtaining the reshaping information of the workpiece based on the comparison result further includes:
obtaining the reshaping information by matching the comparison result with a predetermined reshaping information set.

Therefore, the reshaping information can be obtained by matching the comparison result with a predetermined reshaping information set, the predetermined reshaping information set includes reshaping information corresponding to various deformation situations.

According to some embodiments, the reshaping information is provided with a reshaping method, reshaping amount, and pressure holding time.

Therefore, the workpiece can be reshaped precisely as the reshaping information includes a reshaping method, reshaping amount, and pressure holding time for matching with various deformation situations of workpiece.

According to some embodiments, acquiring position data information of the workpiece, where the position data information is obtained by the measurement system measuring the workpiece further includes:
establishing a coordinate system of the measurement system and binding the coordinate system with the position information of the workpiece; and
moving the measurement system to sequentially measure position data information of the multiple target position points on the workpiece surface.

Therefore, by binding the coordinate system with the position information of the workpiece, the multiple target position points and the position information can be related when the measurement system is moved to sequentially measure position data information of the multiple target position points, and the position data information of the multiple target position points can be acquired accurately.

According to some embodiments, controlling the reshaping system to reshape the workpiece according to the reshaping information further includes:
generating reshaping instructions based on the reshaping information and sending the reshaping instructions to the reshaping system; and
reshaping each position point of the workpiece by the reshaping assembly in the reshaping system according to the reshaping instructions.

Therefore, by generating reshaping instructions based on the reshaping information and sending the reshaping instructions to the reshaping system, the reshaping system reshapes each position point of the workpiece subsequently according to the reshaping instructions. This enables automatic reshaping of the workpiece, reduces manual labor input, and improves the efficiency of workpiece reshaping.

According to some embodiments, the reshaping method further includes:
determining reshaping effect of the workpiece, outputting a first signal if the reshaping is qualified, and outputting a second signal if the reshaping is unqualified;
sending a first command signal based on the first signal, causing the reshaping system to return to its initial position; and
sending a second command signal based on the second signal, causing the reshaping system to perform another reshaping process on the workpiece.

Therefore, by evaluating reshaping effect of the workpiece, the qualified workpiece and the unqualified workpiece can be processed differently. The deformation amount of the unqualified workpiece is reevaluated, and another reshaping process is performed, until it meets the qualification criteria. This improves the qualification rate of workpiece reshaping.

According to some embodiments, an electronic device is provided by the disclosure, the electronic device includes:
a processor; and
a storage device storing computer-readable instructions for execution by the processor to cause the processor to implement the reshaping method of metal product aforementioned.

Therefore, the electronic device achieves electronic control during workpiece reshaping by the processor and the memory. The memory stores the computer program, which can be loaded by the processor to execute the reshaping method for metal product. This simplifies the control procedure and improves reshaping efficiency.

### BRIEF DESCRIPTION OF THE DRAWINGS

Implementations of the present technology will now be described, by way of example only, with reference to the attached figures.

FIG. 1 is a schematic diagram of an electronic device according to an embodiment of the disclosure.

FIG. 2 is a flowchart of a reshaping method for metal product according to an embodiment of the disclosure.

FIG. 3 is a graphic showing a first deformation of a workpiece surface according to an embodiment of the disclosure.

FIG. 4 is a graphic showing a second deformation of the workpiece surface according to an embodiment of the disclosure.

FIG. 5 is a graphic showing a third deformation of the workpiece surface according to an embodiment of the disclosure.

FIG. 6 is a graphic showing a fourth deformation of the workpiece surface according to an embodiment of the disclosure.

FIG. 7 is a graphic showing a fifth deformation of the workpiece surface according to an embodiment of the disclosure.

FIG. 8 is a graphic showing a sixth deformation of the workpiece surface according to an embodiment of the disclosure.

FIG. 9 is a graphic showing a seventh deformation of the workpiece surface according to an embodiment of the disclosure.

FIG. 10 is a graphic showing an eighth deformation of the workpiece surface according to an embodiment of the disclosure.

FIG. 11 is a graphic showing a ninth deformation of the workpiece surface according to an embodiment of the disclosure.

FIG. 12 is a graphic showing a tenth deformation of the workpiece surface according to an embodiment of the disclosure.

FIG. 13 is a graphic showing determination of deformation amount of the workpiece surface according to an embodiment of the disclosure.

FIG. 14 shows part of the reshaping system according to an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the disclosure.

It should be understood that, the terms “first” and “second” are used to distinguish between elements and are not used to denote a particular order or imply a number of technical features, therefore, unless specifically defined otherwise, features described with “first” and “second” may expressly or implicitly include one or more of the stated features. In the description of the present application, “plurality” means two or more, unless otherwise expressly and specifically defined.

In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

The term “comprising,” when utilized, means “including, but not necessarily limited to”; it specifically indicates open-ended inclusion or membership in the so-described combination, group, series, and the like.

The disclosure provides a reshaping method for metal product, including: acquiring position data information of a workpiece, where the position data information is obtained by a measurement system measuring the workpiece; converting the position data information into coordinate information, and fitting the coordinate information to obtain a surface contour curve of the workpiece; comparing the surface contour curve with a standard contour curve to generate a comparison result;
obtaining reshaping information of the workpiece based on the comparison result; and
controlling the reshaping system to reshape the workpiece according to the reshaping information.

Therefore, the disclosure acquires position data information of the workpiece by using the measuring system to measure the surface of the workpiece, converts the position data information into coordinate information, fits the coordinate information to obtain the surface contour curve of the workpiece, compares the surface contour curve with the standard contour curve to obtain deformation situation to obtain the comparison result, obtains the reshaping information, and controls the reshaping system to reshape the workpiece according to the reshaping information. The disclosure automatic reshapes the workpiece according to the reshaping information based on deformation situation of the workpiece obtained by comparing the surface contour curve with the standard contour curve, which improves efficiency of workpiece reshaping and reducing labor costs.

According to some embodiments, an electronic device is provided by the disclosure, the electronic device includes:
a processor; and
a storage device storing computer-readable instructions for execution by the processor to cause the processor to implement the reshaping method of metal product aforementioned.

Therefore, the electronic device achieves electronic control during workpiece reshaping by the processor and the memory. The memory stores the computer program, which can be loaded by the processor to execute the reshaping method for metal product. This simplifies the control procedure and improves reshaping efficiency.

The hereinafter-described embodiments of the disclosure are presented herein by way of exemplification and not limitation, with reference to the figures.

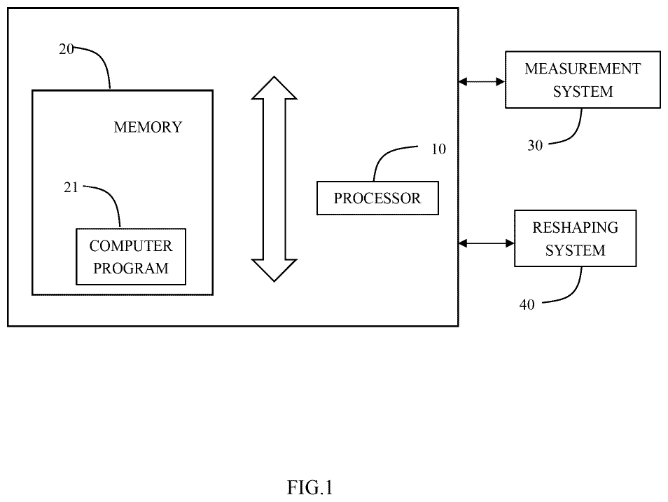

FIG. 1 illustrates a schematic diagram of an electronic device provided in an embodiment of the disclosure. An electronic device 100 includes, but is not limited to, a processor 10, a memory 20, a measurement system 30, and a reshaping system 40. The measurement system 30 is used to measure a workpiece and obtain position data information of the workpiece. The processor 10 is connected to the measurement system 30 for acquiring the position data information measured by the measurement system 30 and processing it. The reshaping system 40 is connected to the processor 10 for executing reshaping instructions sent by the processor 10 to reshape the workpiece.

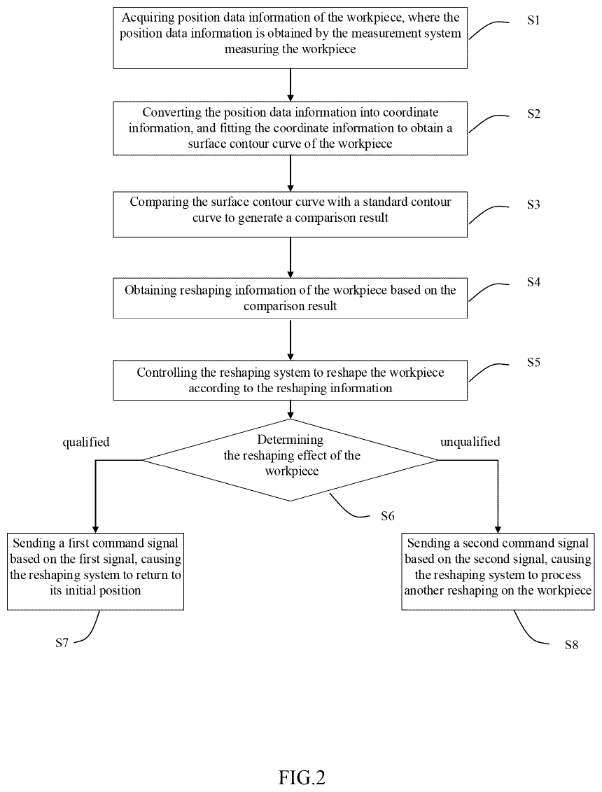

FIG. 2 is a flowchart of the reshaping method for metal product provided in an embodiment. The sequence of steps in the flowchart may vary and certain steps may be skipped depending on specific requirements. The reshaping method for metal product includes:

S1: Acquiring position data information of the workpiece, where the position data information is obtained by the measurement system 30 measuring the workpiece.

The position data information of the workpiece includes height values between multiple target position points on the workpiece surface and the measurement system 30. Specifically, the workpiece is fixed in a predetermined position, and the measurement system 30 is moved above the workpiece, and the measurement system 30 moves in a predetermined plane to measure a surface of the workpiece to acquire the position data information of the workpiece. For example, there is a target position point A on the workpiece surface, the measurement system 30 measures the position of point A to obtain a height value between point A and the measurement system 30. In this embodiment, the measurement system 30 may be a laser measurement system.

According to this embodiment, the measurement system 30 is connected to the processor 10, and the processor 10 directly retrieves the position data information of the workpiece measured by the measurement system 30 through a serial communication protocol. Specifically, the serial communication protocol used is Modbus/TCP. It should be understood that the measurement system 30 can also send the measured position data information to the processor 10 in real-time.

According to some embodiments, step S1 includes: establishing a coordinate system of the measurement system 30 and binding the coordinate system with the position information of the workpiece; and moving the measurement system 30 to sequentially measure position data information of the multiple target position points on the workpiece surface.

The coordinate system is a three-dimensional coordinate system. Specifically, the coordinate system is bound with the position information of the workpiece to establish a one-to-one correspondence between coordinate values in the coordinate system and position points on the workpiece.

In specific, the measurement system 30 moves along a predetermined trajectory to measure position of the multiple target position points on the workpiece surface to acquire the position data information of the multiple target position points.

The predetermined trajectory may be a trajectory of moving along a lengthwise direction of the workpiece.

S2: converting the position data information into coordinate information, and fitting the coordinate information to obtain a surface contour curve of the workpiece.

In this step, the processor 10 establishes a predetermined coordinate system, the predetermined coordinate system is bound with the position information of the workpiece to establish a correspondence between coordinate points in the coordinate system and the multiple position points on the workpiece, such that each position point has a corresponding coordinate point in the predetermined coordinate system. Based on this one-to-one correspondence, the known position data information of different position points on the workpiece is used to determine corresponding coordinate information. The coordinate information represents coordinate values of the respective position points on the workpiece. For example, the position data information of a target position point A on the workpiece surface is a height value Ha between the target position point A and the measurement system 30. According to the one-to-one correspondence between the position points on the workpiece and the coordinate values in the coordinate system, the target position point A has a unique coordinate value (Xa, Ya, Za) in the coordinate system.

According to this embodiment, the fitting process utilizes a least squares method to obtain the contour curve of the workpiece surface based on the coordinate values corresponding to multiple position points on the surface of the workpiece.

The fitting process in this embodiment connects coordinate values of multiple discrete position points using a curve to visualize the contour of the workpiece surface, making the contour clearer and more intuitive.

According to some embodiments, S2 includes: establishing a measurement coordinate system and binding the measurement coordinate system with the position information of the workpiece; converting the position data information into coordinate information based on the binding between the measurement coordinate system and the position information of the workpiece; fitting the coordinate information to obtain the surface contour curve of the workpiece.

The measurement coordinate system is established within the processor 10, and it is bound with the position information of the workpiece to establish a correspondence between the position points on the workpiece surface and the corresponding coordinate values in the measurement coordinate system, allowing a one-to-one correspondence between the position points on the workpiece surface and the corresponding coordinate values in the measurement coordinate system. Based on this correspondence, the known position information of different position points on the workpiece is used to obtain corresponding coordinate information of the different position points. The coordinate information represents the coordinate values corresponding to the position points on the workpiece. The least squares method is utilized to fit the coordinate information to obtain the surface contour curve of the workpiece, such that the contour curve of the workpiece surface is obtained by measurement and calculations. This facilitates analysis of the deformation of the workpiece and enables visualization of the deformation of the workpiece. In this embodiment, the surface contour curve represents contour line of the workpiece surface.

According to some embodiments, fitting the coordinate information to obtain the surface contour curve of the workpiece includes: obtaining the coordinate values (X, Y, Z) of each target position point on the workpiece based on the correspondence between the coordinate information and each position point; calculating an ideal plane equation Z=AX+BY+C to obtain a planarity deviation value of each position point on the workpiece by the multi-point least squares method; fitting and obtaining the surface contour curve of the workpiece based on the calculated planarity deviation value of each position point on the workpiece.

For example, assuming there are nine target position points (N=9), the coordinate values of the nine target position points are respectively (Xi, Yi, Zi), (i=1, 2, 3, . . . , 9).

According to the multi-point least squares method, the objective function is: F(A, B, C)=Σᵢ₌₁ⁿ(AXi+BYi+C−Zi)², according to the extremum principle, when F(A, B, C) has a minimum value,

$$\frac{\partial F}{\partial A} = 0 , \frac{\partial F}{\partial B} = 0 , \frac{\partial F}{\partial C} = 0 ,$$

that is,

$$\{ \begin{matrix}\frac{\partial F}{\partial A} = {\sum }_{i = 1}^{n} 2 Xi ( AXi + BYi + C - Zi ) = 0 \\ \frac{\partial F}{\partial B} = {\sum }_{i = 1}^{n} 2 Yi ( AXi + BYi + C - Zi ) = 0 \\ \frac{\partial F}{\partial A} = {\sum }_{i = 1}^{n} 2 ( AXi + BYi + C - Zi ) = 0\end{matrix}$$

Under the condition of knowing (Xi, Yi, Zi), plane parameters A, B, C corresponding to each target position point can be obtained based on the above formula.

The planarity deviation value represents the distance between the actual surface of the workpiece and ideal plane of the workpiece, the surface contour curve refers to the actual workpiece surface.

Specifically, the surface contour curve of the workpiece is obtained by the fitting process based on the obtained planarity parameters A, B, C of each target position point, and the deformation of the workpiece is visualized.

The fitting process connects multiple discrete target position points on the workpiece surface with a smooth curve to graphically display the contour of the workpiece surface, making the surface contour of the workpiece clearer.

S3: comparing the surface contour curve with a standard contour curve to generate a comparison result.

Deformation amount corresponding to each target position point on the workpiece can be obtained by comparing the surface contour curve with the standard contour curve. The deformation amount of each position point is judged to determine whether it falls within a predetermined range, and corresponding judgement results are generated, then the comparison result is generated based on the judgement results of the target position points whose deformation amount is beyond the predetermined range.

In this embodiment, the deformation amount refers to the distance between the target position points on the surface contour curve of the workpiece and the corresponding position points on the standard contour curve of the standard workpiece. For example, if the distance between a target position point A on the surface contour curve of the workpiece and a position point A′ corresponding to the target position point A on the standard contour curve of the standard workpiece is 0.2 mm, then the deformation amount of target position point A after comparison is 0.2 mm. The predetermined range refers to a pre-set acceptable limit, such as 0.25 mm, then the deformation amount is within 0.25 mm, and the workpiece is considered acceptable and does not require reshaping. Otherwise, the workpiece is considered unacceptable.

According to some embodiments, the step S3 includes: comparing the surface contour curve with the standard contour curve to generate the deformation amount of each target position point on the workpiece; generating a judgment result by determining whether the deformation amount of each target position point falls within the predetermined range; generating the comparison result based on the judgment result.

Specifically, the standard contour curve refers to the contour curve of the standard workpiece. By comparing the surface contour curve of the workpiece with the standard contour curve of the standard workpiece, the deformation amount corresponding to each target position point on the workpiece is obtained.

It should be understood that the workpiece and the standard workpiece belong to the same type of product, and there is a one-to-one correspondence between the position points of the workpiece and the position points of the standard workpiece.

The predetermined range is a criterion for determining the acceptability of the workpiece. For example, the predetermined range is 0.25 mm. Based on this setting, if the deformation amount of position point A on the workpiece surface exceeds 0.25 mm, then the deformation of point A is beyond the predetermined range.

Further, generating a judgment result by determining whether the deformation amount of each target position point on the workpiece falls within the predetermined range includes: if the deformation amount of each target position point falls within the predetermined range, then the workpiece is determined to be qualified; if the deformation amount of at least one position point is outside the predetermined range, then the workpiece is determined to be unqualified.

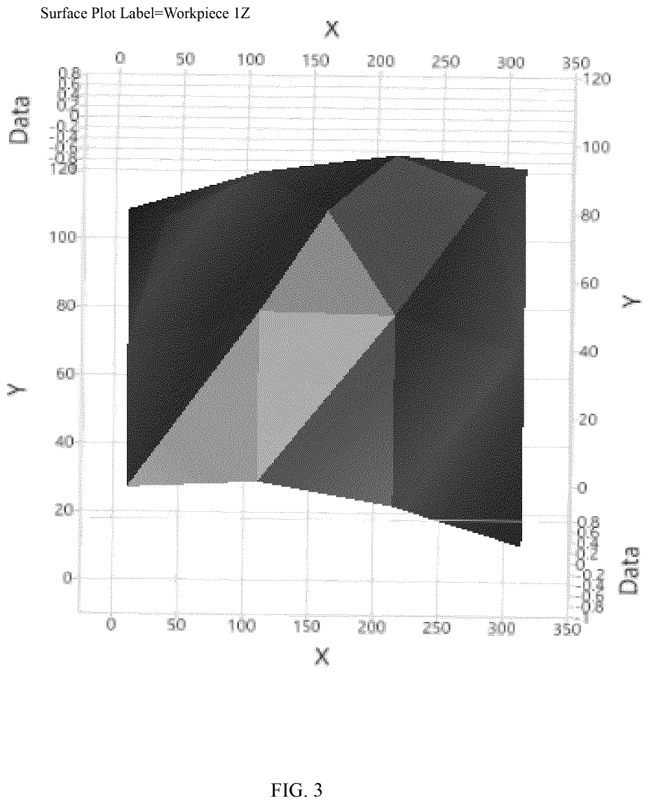

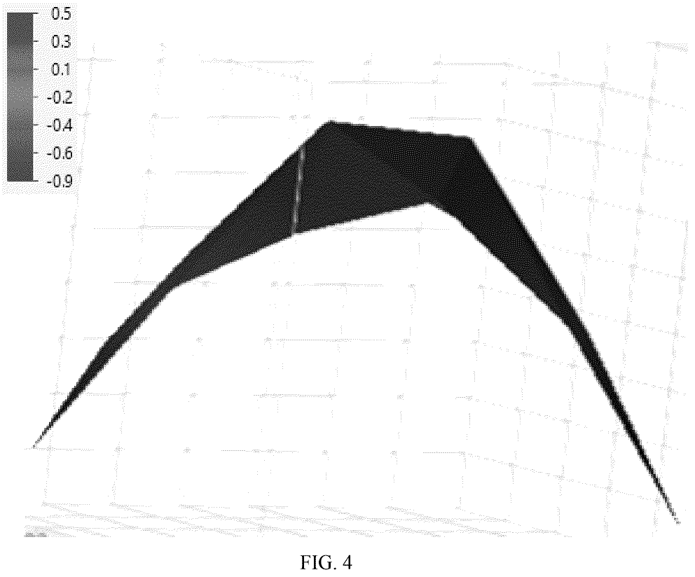

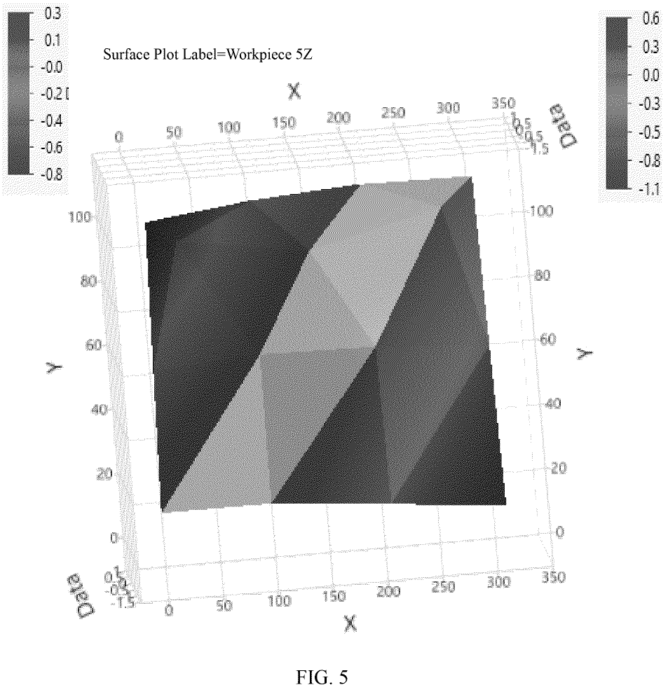

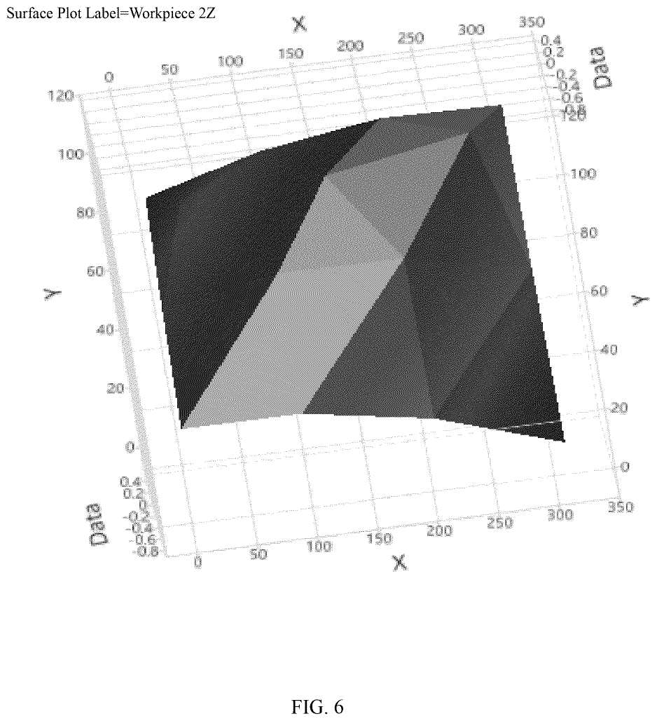

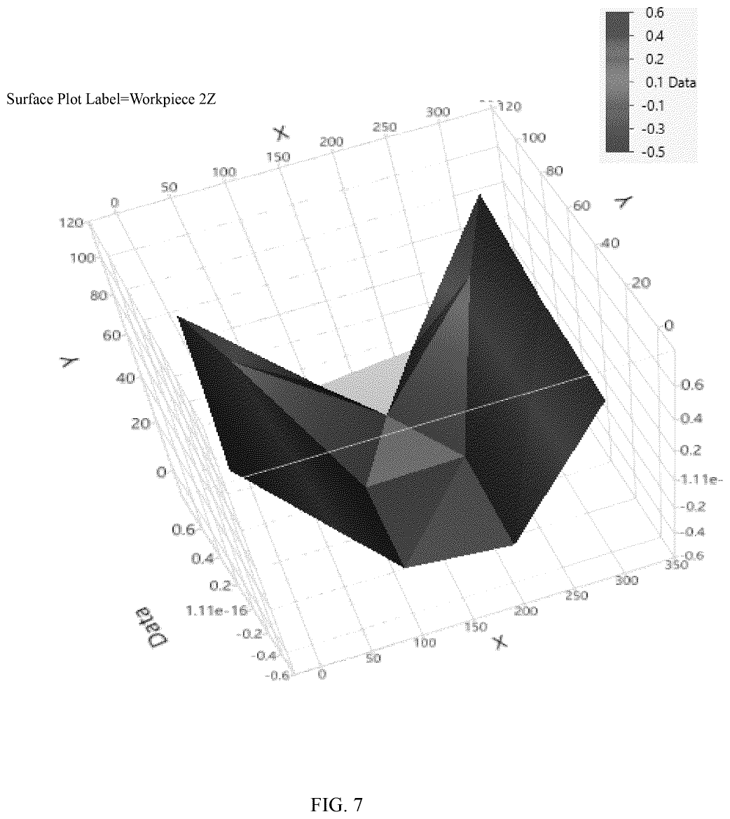

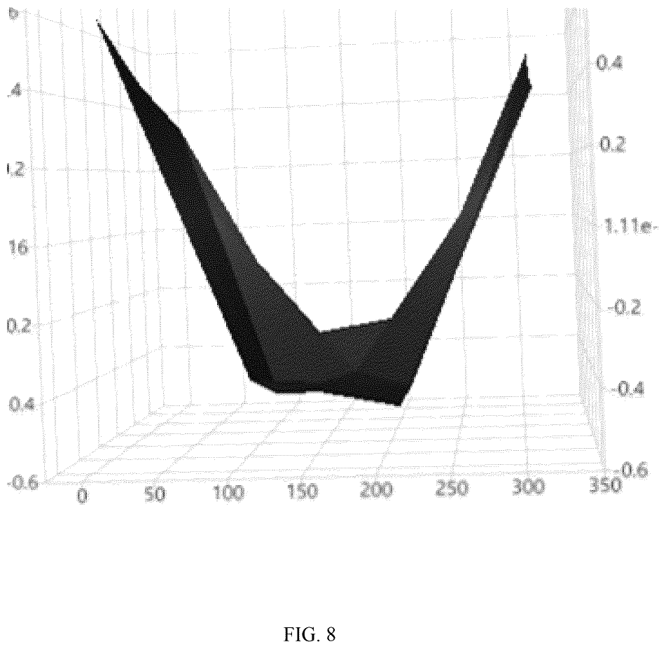

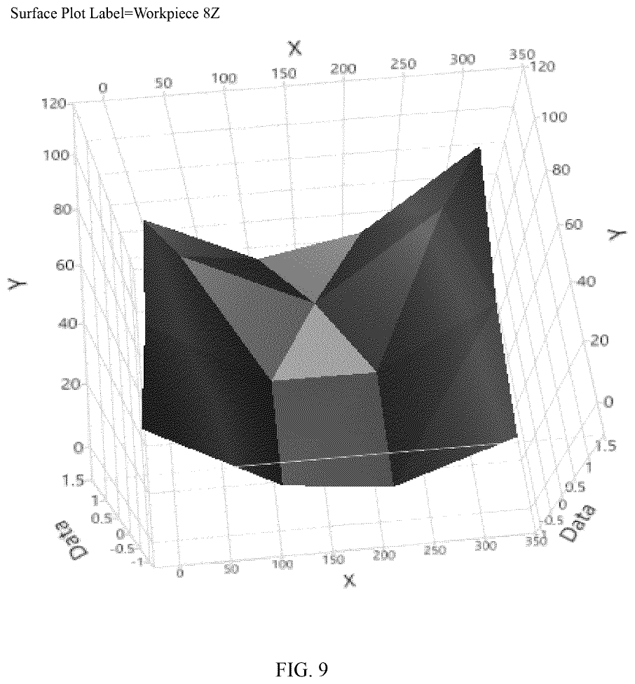

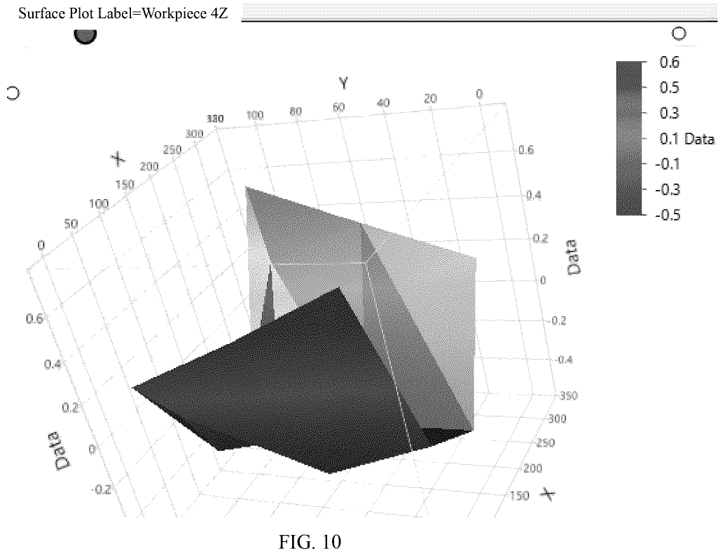

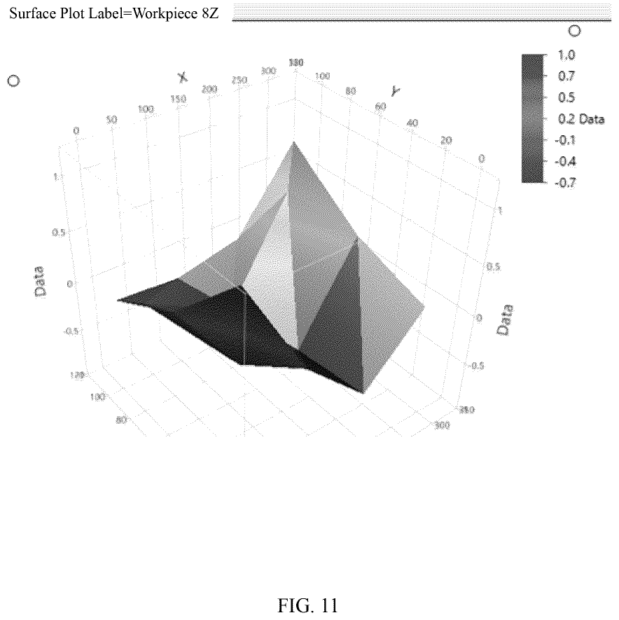

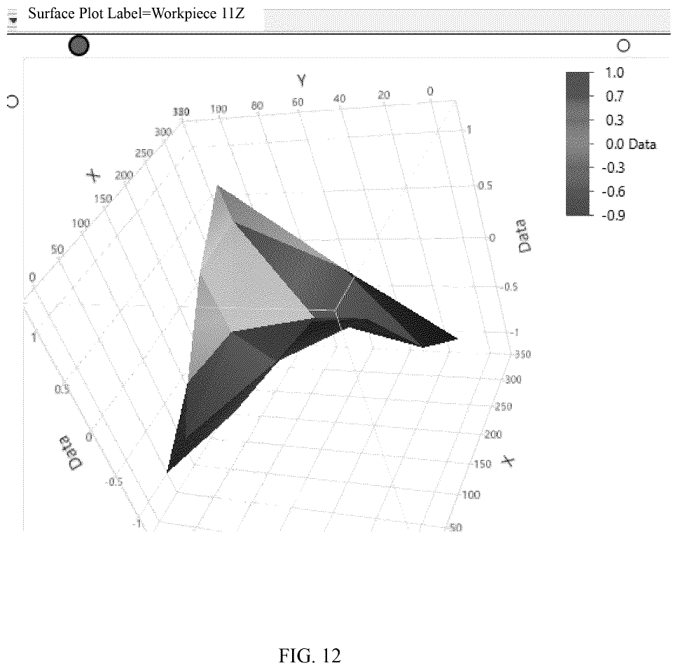

FIGS. 3 to 12 are graphics illustrating ten types of deformations on the surface of the workpiece provided in this application embodiment, Referring to FIGS. 3-12, the workpiece is in a three-dimensional coordinate system, which is bound with the position information of the workpiece and shares the same coordinate system as the measurement system 30. The measurement system 30 measures the positions of multiple target position points on the workpiece surface to obtain the position data information of each target position point, and convert the position data information of each target position point into coordinate information of each target position point in the three-dimensional coordinate system. For example, the coordinate information of a target position point A is (Xa, Ya, Za). By placing the workpiece in a predefined position, the deformation of the workpiece can be determined based on the coordinate information of each target position point. It should be understood that, the above examples of workpiece deformations represent only a part of the possible deformations, and the deformations of the workpiece can be defined based on the deformations of various target position points through different arrangements and combinations.

As an example, a plane of the predefined position where the workpiece is placed is parallel to the X/Y plane in the three-dimensional coordinate system, the deformation of the workpiece at each target position point can be determined by examining the Z-axis coordinate values of the coordinate information of each target position point on the workpiece. For example, if the acceptable range of deformation is set to (±0.25 mm), and the Z-axis coordinate of the target position point A is 0.3 mm, then the target position point A exceeds the acceptable deformation range by 0.25 mm, indicating an upward bulge deformation. If the Z-axis coordinate of a target position point B is −0.3 mm, then the target position point B exceeds the acceptable deformation range of −0.25 mm, indicating a downward concave deformation.

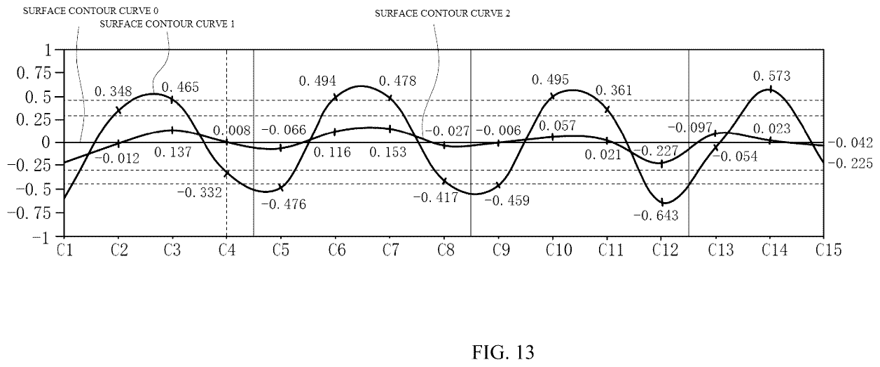

In FIG. 13 is a graphic showing determination of deformation amount of the workpiece surface according to an embodiment of the disclosure. The, the surface contour curve 0 represents the standard contour curve of the workpiece, the surface contour curve 1 represents the surface contour curve of the workpiece before reshaping, and the surface contour curve 2 represents the surface contour curve of the workpiece after reshaping. It can be understood that when comparing the workpiece surface contour curve with the standard contour curve, if the deformation amount of each target position point falls within the range of (f0.25 mm) of the standard contour curve, the workpiece is considered qualified. For example, if the deformation amount of the target position point A on the workpiece surface is 0.1 mm, then the deformation amount of the target position point A does not exceed the predetermined range (f0.25 mm), the workpiece is determined to be qualified, and reshaping is not required for point A. However, if the deformation amount of target position point A on the workpiece surface is 0.3 mm, then the deformation amount of point A exceeds the predetermined range (±0.25 mm), the workpiece is determined to be unqualified, and reshaping is required for point A.

Specifically, by comparing the deformation amount of each target position point with the predetermined range, the result of whether the deformation amount of each target position point falls within the predetermined range is obtained. Based on the judgment result, the comparison result is obtained to acquire the deformation situation of different target position points on the surface of the workpiece. For example, there are nine target position points on the workpiece surface, the deformation amount of each of the nine position points is compared with the predetermined range to determine whether the deformation amount of each of the nine position points falls within the predetermined range.

S4: obtaining reshaping information of the workpiece based on the comparison result.

Specifically, the reshaping information includes a reshaping method, reshaping amount, and pressure holding time. These parameters are matched with the deformation situation of different workpieces to achieve precise reshaping of each workpiece.

For example, there are nine target position points on the workpiece, and the deformation amounts of four of them exceed the predetermined range, then the best reshaping method, reshaping amount, and pressure holding time are selected from a predetermined reshaping information set based on the deformation amounts at the four target position points.

It should be understood that the pressure holding time refers to duration of applying pressure to the workpiece after reshaping, which helps eliminate the stress in the reshaped workpiece and improve the reshaping effectiveness.

S5: controlling the reshaping system 40 to reshape the workpiece according to the reshaping information.

In this embodiment, the processor 10 obtains the reshaping information and sends the reshaping information to the reshaping system 40. The reshaping system 40 reshapes the surface of the workpiece based on the received reshaping information.

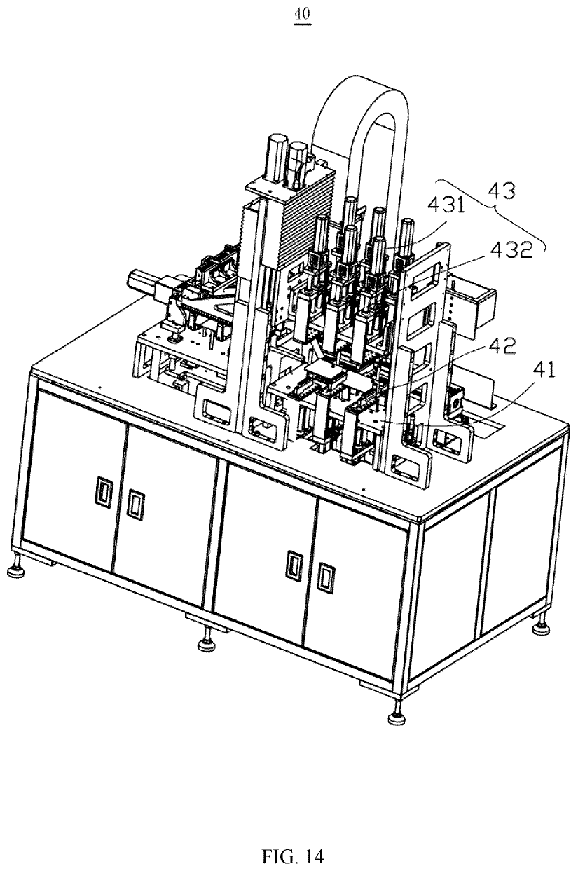

In FIG. 14 shows part of the reshaping system provided in this embodiment. The reshaping system 40 includes a worktable 41, a positioning assembly 42, and a reshaping assembly 43. The positioning assembly 42 is used to position the workpiece on the worktable 41. There are N target position points on the workpiece surface, N≥1, then the reshaping assembly 43 includes 2N drive members 431 and 2N transmission members 432, each transmission member 432 is connected to one of the drive members 431. The drive members 431 are used to drive the transmission members 432 to move towards or away from the workpiece. The 2N drive members 431 are symmetrically arranged on both sides of the worktable 41 along the plane where the workpiece is placed, such that the reshaping system 40 controls the corresponding drive members 431 to drive the transmission members 432 to reshape the surface of the workpiece based on the received reshaping information.

In this embodiment, the drive members 431 are servos, and the transmission members 432 are lead screws.

According to some embodiments, referring to FIG. 2, step S5 includes generating reshaping instructions based on the reshaping information and sending the reshaping instructions to the reshaping system 40; the reshaping assembly 43 in the reshaping system 40 starts working according to the reshaping instructions to sequentially reshape each position point of the workpiece.

In this embodiment, the reshaping system 40 further includes a controller (not shown). Specifically, the processor 10 is connected to the controller via Modbus/TCP communication to send the reshaping information to the controller. The controller automatically generates reshaping instructions based on the received reshaping information. The controller is a PLC controller. The controller is connected to the reshaping system 40 via the CANlink protocol. The controller sends the reshaping instructions to the reshaping system 40, and the reshaping system 40 sequentially reshapes each target position point of the workpiece based on the reshaping instructions. This enables automatic reshaping of the workpiece, reduces manual labor input, and improves the efficiency of workpiece reshaping.

S6: determining the reshaping effect of the workpiece, outputting a first signal if the reshaping is qualified, and outputting a second signal if the reshaping is unqualified.

After reshaping the workpiece once, the measurement system 30 reacquires the position data information of the reshaped workpiece surface, which is transformed into the coordinate information of the reshaped workpiece surface based on the reshaped position data information. The coordinate information is fitted to obtain the surface contour curve of the reshaped workpiece. The reshaped surface contour curve is then compared with the standard contour curve of the standard workpiece to determine the reshaping effect of the reshaped workpiece. If the reshaping is qualified, a first signal is output. If the reshaping is unqualified, a second signal is output.

Referring to FIG. 2, S7: sending a first command signal based on the first signal, causing the reshaping system 40 to return to its initial position.

Based on the first signal indicating that the reshaped workpiece is qualified, the processor 10 sends the first command signal to return the reshaping system 40 to its initial position, preparing for reshaping the next workpiece.

Referring to FIG. 2, S8: sending a second command signal based on the second signal, causing the reshaping system 40 to perform another reshaping process on the workpiece.

Based on the second signal indicating that the reshaped workpiece is unqualified, the processor 10 sends the second command signal to initiate another reshaping of the same workpiece.

By evaluating the reshaping effect of the workpiece after each reshaping process, the qualified and unqualified workpieces are processed differently. The deformation amount of the unqualified workpiece is reevaluated, and another reshaping process is performed, until it meets the qualification criteria. This improves the qualification rate of workpiece reshaping.

Please refer to FIG. 1 again. The electronic device 100 includes a processor 10 and a memory 20. The memory 20 stores a computer program 21, which is loaded and executed by the processor 10 to implement any of the aforementioned reshaping methods for metal product.

In this way, the electronic device 100 achieves electronic control during workpiece reshaping by the processor 10 and the memory 20. The memory 20 stores the computer program 21, which can be loaded by the processor 10 to execute the reshaping method for metal product. This simplifies the control procedure and improves reshaping efficiency.

Those skilled in the art will understand that the schematic diagram is merely an example of the electronic device 100 and does not limit the electronic device 100. It may include more or fewer components, or a combination of certain components, or different components. For example, the electronic device 100 may also include input/output devices, network access devices, buses, and so on.

The processor 10 can be a Central Processing Unit (CPU) or other general-purpose processors such as a Digital Signal Processor (DSP), Application Specific Integrated Circuit (ASIC), Field-Programmable Gate Array (FPGA), or other programmable logic devices, discrete gates or transistor logic devices, discrete hardware components, etc. The general-purpose processor can be a microprocessor or any conventional processor. The processor 10 serves as the control center of the electronic device 100 and is connected to various parts of the electronic device 100 through various interfaces and lines.

The memory 20 can be used to store computer programs 21 and/or modules/units. The processor 10 runs or executes the computer programs 21 and/or modules/units stored in the memory 20, and accesses data stored in the memory 20 to implement various functions of the electronic device 100. The memory 20 can mainly include a program storage area and a data storage area. The program storage area can store an operating system, at least one application program required for the functions, etc. The data storage area can store data created based on the usage of the electronic device 100. In addition, the memory 20 can include volatile and non-volatile memory, such as a hard disk, memory, plug-in hard disk, Smart Media Card (SMC), Secure Digital (SD) card, flash card, at least one disk storage device, flash memory device, or other storage devices.

The reshaping method for metal product and electronic device 100 provided in this application can obtain position data information of the workpiece by using the measurement system 30 to measure the workpiece surface. The position data information is converted into coordinate information. The coordinate information is then fitted using the least squares method to obtain the surface contour curve of the workpiece. The obtained surface contour curve is compared with the standard contour curve to obtain a comparison result. Based on the comparison result, the reshaping information of the workpiece is obtained. The reshaping system 40 is then controlled based on the reshaping information to reshape the workpiece. This process evaluates the degree of deformation of the workpiece based on the comparison between the surface contour curves and standard contour curve, and automatically reshapes the workpiece according to the degree of deformation, thereby improving the efficiency of workpiece reshaping and reducing labor costs.

While the invention has been described in detail in connection with only a limited number of embodiments, it should be readily understood for the skilled in the art that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A reshaping method for metal product, comprising:
acquiring position data information of a workpiece, the position data information is obtained by a measurement system measuring the workpiece;
converting the position data information into coordinate information, and fitting the coordinate information to obtain a surface contour curve of the workpiece;
comparing the surface contour curve with a standard contour curve to generate a comparison result;
obtaining reshaping information of the workpiece based on the comparison result; and
controlling a reshaping system to reshape the workpiece according to the reshaping information.

2. The reshaping method of claim 1, wherein converting the position data information into coordinate information, and fitting the coordinate information to obtain a surface contour curve of the workpiece further comprises:
establishing a measurement coordinate system and binding the measurement coordinate system with the position information of the workpiece,
converting the position data information into coordinate information based on the binding between the measurement coordinate system and the position information of the workpiece, and
fitting the coordinate information to obtain the surface contour curve of the workpiece.

3. The reshaping method of claim 2, wherein fitting the coordinate information to obtain the surface contour curve of the workpiece further comprises:
obtaining coordinate values (X, Y, Z) of each target position point on the workpiece based on a correspondence between the coordinate information and each position point,
calculating an ideal plane equation Z=AX+BY+C to obtain a planarity deviation value of each position point on the workpiece by a multi-point least squares method, and
fitting and obtaining the surface contour curve of the workpiece based on the obtained planarity deviation value of each position point on the workpiece.

4. The reshaping method of claim 1, wherein comparing the surface contour curve with a standard contour curve to generate a comparison result further comprises:
comparing the surface contour curve with the standard contour curve to obtain a deformation amount of each target position point on the workpiece,
generating a judgment result by determining whether the deformation amount of each target position point falls within a predetermined range, and
generating the comparison result based on the judgment result.

5. The reshaping method of claim 4, wherein generating the judgment result by determining whether the deformation amount of each target position point falls within the predetermined range further comprising:
determining the workpiece to be qualified if the deformation amount of each target position point of the workpiece falls within the predetermined range, and
determining the workpiece to be unqualified if the deformation amount of at least one target position point is outside the predetermined range.

6. The reshaping method of claim 1, wherein obtaining the reshaping information of the workpiece based on the comparison result further comprises:
obtaining the reshaping information by matching the comparison result with a predetermined reshaping information set.

7. The reshaping method of claim 6, wherein the reshaping information is provided with a reshaping method, reshaping amount, and pressure holding time.

8. The reshaping method of claim 1, wherein acquiring the position data information of the workpiece further comprises:
establishing a coordinate system of the measurement system and binding the coordinate system with the position information of the workpiece, and
moving the measurement system to sequentially measure position data information of the multiple target position points on the workpiece surface.

9. The reshaping method of claim 1, wherein controlling the reshaping system to reshape the workpiece according to the reshaping information further comprises:
generating reshaping instructions based on the reshaping information and sending the reshaping instructions to the reshaping system, and
reshaping each position point of the workpiece by a reshaping assembly in the reshaping system according to the reshaping instructions.

10. The reshaping method of claim 1, further comprising:
determining reshaping effect of the workpiece, outputting a first signal if the reshaping is qualified, and outputting a second signal if the reshaping is unqualified;
sending a first command signal based on the first signal, causing the reshaping system to return to its initial position; and
sending a second command signal based on the second signal, causing the reshaping system to perform another reshaping process on the workpiece.

11. (canceled)

12. An electronic device comprising:
at least one processor; and
a storage device coupled to the at least one processor and storing computer-readable instructions for execution by the at least one processor to cause the at least one processor to implement a reshaping method of metal product, the method comprising:
acquiring position data information of a workpiece, the position data information is obtained by a measurement system measuring the workpiece;
converting the position data information into coordinate information, and fitting the coordinate information to obtain a surface contour curve of the workpiece;
comparing the surface contour curve with a standard contour curve to generate a comparison result;
obtaining reshaping information of the workpiece based on the comparison result; and
controlling a reshaping system to reshape the workpiece according to the reshaping information.

13. The electronic device of claim 12, wherein converting the position data information into coordinate information, and fitting the coordinate information to obtain a surface contour curve of the workpiece further comprises:
establishing a measurement coordinate system and binding the measurement coordinate system with the position information of the workpiece,
converting the position data information into coordinate information based on the binding between the measurement coordinate system and the position information of the workpiece, and
fitting the coordinate information to obtain the surface contour curve of the workpiece.

14. The electronic device of claim 13, wherein fitting the coordinate information to obtain the surface contour curve of the workpiece further comprises:
obtaining coordinate values (X, Y, Z) of each target position point on the workpiece based on a correspondence between the coordinate information and each position point,
calculating an ideal plane equation Z=AX+BY+C to obtain a planarity deviation value of each position point on the workpiece by a multi-point least squares method, and
fitting and obtaining the surface contour curve of the workpiece based on the obtained planarity deviation value of each position point on the workpiece.

15. The electronic device of claim 12, wherein comparing the surface contour curve with a standard contour curve to generate a comparison result further comprises:
comparing the surface contour curve with the standard contour curve to obtain a deformation amount of each target position point on the workpiece,
generating a judgment result by determining whether the deformation amount of each target position point falls within a predetermined range, and
generating the comparison result based on the judgment result.

16. The electronic device of claim 15, wherein generating the judgment result by determining whether the deformation amount of each target position point falls within the predetermined range further comprising:
determining the workpiece to be qualified if the deformation amount of each target position point of the workpiece falls within the predetermined range, and
determining the workpiece to be unqualified if the deformation amount of at least one target position point is outside the predetermined range.

17. The electronic device of claim 12, wherein obtaining the reshaping information of the workpiece based on the comparison result further comprises:
obtaining the reshaping information by matching the comparison result with a predetermined reshaping information set.

18. The electronic device of claim 17, wherein the reshaping information is provided with a reshaping method, reshaping amount, and pressure holding time.

19. The electronic device of claim 12, wherein acquiring the position data information of the workpiece further comprises:
establishing a coordinate system of the measurement system and binding the coordinate system with the position information of the workpiece, and
moving the measurement system to sequentially measure position data information of the multiple target position points on the workpiece surface.

20. The electronic device of claim 12, wherein controlling the reshaping system to reshape the workpiece according to the reshaping information further comprises:
generating reshaping instructions based on the reshaping information and sending the reshaping instructions to the reshaping system, and
reshaping each position point of the workpiece by a reshaping assembly in the reshaping system according to the reshaping instructions.

21. The electronic device of claim 12, further comprising:
determining reshaping effect of the workpiece, outputting a first signal if the reshaping is qualified, and outputting a second signal if the reshaping is unqualified;
sending a first command signal based on the first signal, causing the reshaping system to return to its initial position; and
sending a second command signal based on the second signal, causing the reshaping system to perform another reshaping process on the workpiece.
